(19) United States
(12) Patent Application Publication
(10) Pub. No.: US 2007/0187397 A1
(43) Pub. Date: Aug. 16, 2007

(54) Frozen food package and method of use

(76) Inventor: Eric A. Carre, Grayslake, IL (US)

Correspondence Address: SAND & SEBOLT, AEGIS TOWER, SUITE 1100, 4940 MUNSON STREET, NW, CANTON, OH, 44718-3615, US

(21) Appl. No.: 11/351,766

(22) Filed: Feb. 10, 2006

(51) Int. Cl. H05B 6/80

(52) U.S. Cl. 219/725

(57) ABSTRACT

A frozen food package and method of using the same is disclosed. The food package includes a bag which is freezable, ovenable and microwaveable. A frozen food assembly within the bag includes uncooked food, preferably an entree. Typically, the food assembly includes a meat, a fruit or vegetable, and a flavoring liquid such as infused oil, stock or a dairy product. The uncooked food and frozen liquid are typically shaped to facilitate aligning the frozen food with a display window of the bag. Preferably the food assembly is free of chemical preservatives and need not use preformed sauces. The method typically includes providing the frozen uncooked food in the bag, sealing the bag so that the bag is impermeable to liquids, and cooking the food in the bag while the bag is sealed. The resulting cooked dish is a substantial improvement over the well-known precooked frozen meals.

### BACKGROUND OF THE INVENTION

1. Technical Field

The present invention relates generally to food bags and a method of using the same. More particularly, the invention relates to a food bag in which an entree or other food item may be cooked. Specifically, the invention relates to such a food bag in which frozen uncooked food may be stored, displayed and cooked in a standard or microwave oven.

2. Background Information

Amongst the various containers in which food may be cooked, there are a few bags formed of paper, plastic or a combination thereof which typically allow for the heating or cooking of a limited range of food items. For example, certain popcorn bags allow for the cooking of popcorn in a microwave oven. Such bags allow for the expansion thereof due to vaporization of water within the popcorn. However, such bags have an opening end which easily opens during the popping process in order to allow the exhaust of steam and the like from the bag. Thus, such bags are not suitable for cooking food items which include a significant amount of liquid which would drain out of such a bag and make a substantial mess and potentially cause safety hazards.

In addition, there are various types of frozen food items which are typically stored in trays and normally referred to as TV dinners. TV dinners and the like utilize precooked ingredients which result in a relatively dry entree or other food when heated in a microwave or standard oven.

More recent developments include food bags having a window for displaying the food wherein the bags are ovenable, microwaveable and freezable. For example, U.S. Pat. No. 6,033,114 granted to Grimm et al. provides such a bag. This food bag includes an inner layer which is transparent and formed of a plastic sheet or film and an outer layer which is substantially opaque and typically made of paper. A portion of the plastic sheet provides the window through which food items are visible and provides a barrier to moisture, oil and aroma while also being breathable and heat sealable. The preferred material of this bag is a polyester material commercially available as “MYLAR”®. Said bag is configured for packaging heated, greasy food items for display in the carry-out food industry. Thus, for instance, a rotisserie chicken or other moist food item which has been cooked may be displayed in this bag, purchased by a consumer and reheated at home in a standard or microwave oven with leftovers stored in a bag in the freezer for later consumption.

Thus, the use of a food bag for displaying a cooked food item and reheating the food item therein is known in the art. However, there is still a need in the art for frozen meals or other food items which can be displayed in a store and cooked at home. More particularly, there is a need in the art for such frozen foods which are primarily made from fresh, uncooked ingredients.

### BRIEF SUMMARY OF THE INVENTION

The present invention provides an apparatus comprising a bag which is freezable and at least one of ovenable and microwaveable; and a frozen food assembly which includes uncooked food and is disposed within the bag.

The present invention further provides a method comprising the steps of providing frozen uncooked food in a bag; sealing the bag so that the bag is impermeable to liquids; and cooking the food in the bag while the bag is sealed.

### BRIEF DESCRIPTION OF THE SEVERAL VIEWS OF THE DRAWINGS

FIG. 1 is perspective view of the frozen food package of the present invention showing the frozen food items visible through the window of the bag.

FIG. 2 is a perspective view of the freezing tray in which the food items of the present invention are frozen prior to insertion in the food bag.

FIG. 3 is a perspective view similar to FIG. 2 showing the uncooked food items having been placed in the tray prior to the freezing thereof.

FIG. 4 is a diagrammatic view showing the tray in a freezer with the food items having been frozen in the freezing tray to produce a frozen molded dish.

FIG. 5 is a diagrammatic view showing the frozen molded dish being inserted into the food bag.

FIG. 6 is a fragmentary side elevational view showing the bag having been heat sealed.

FIG. 6A is a view similar to FIG. 6 showing the bag being additionally sealed by an adhesive.

FIG. 7 is a diagrammatic elevational view of a plurality of the food bags on display in a store freezer section.

FIG. 8 is a diagrammatic side elevational view showing the frozen food package in an oven at an initial stage of cooking.

FIG. 9 is similar to FIG. 8 and shows the food bag having expanded as a result of the cooking process.

FIG. 10 shows the food bag having been opened and the cooked food items being removed therefrom onto a plate.

Similar numbers refer to similar parts throughout the drawings.

### DETAILED DESCRIPTION OF THE INVENTION

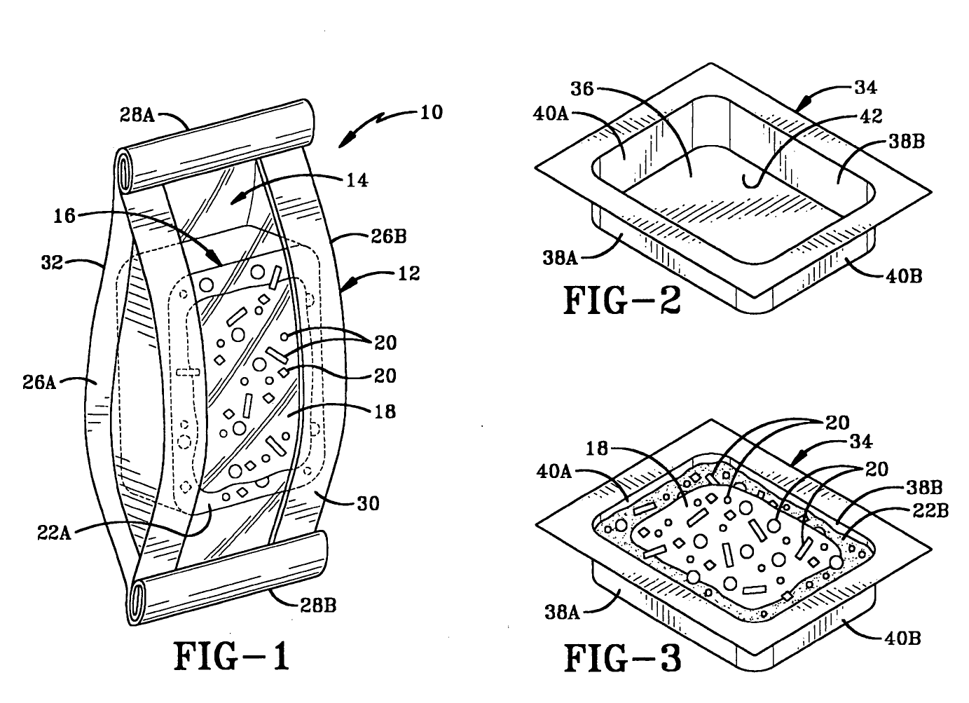

The frozen food package of the present invention is indicated generally at 10 in FIG. 1 and the method of preparing and using the food package is described with reference to FIGS. 2-10. As shown in FIG. 1, food package 10 includes a food bag 12 having a transparent window 14 and a frozen food item or assembly 16 which is typically in the form of an entree. Food assembly 16 is primarily formed of frozen fresh, uncooked ingredients. Food assembly 16 typically includes a meal-sized source of protein most often in the form of a meat 18 or for instance a bean-based food item. Food assembly 16 typically also includes pieces 20 of vegetables, fruits, spices or the like. Food assembly 16 typically further includes a frozen liquid 22A which may involve the use of water, oil (preferably an infused oil), meat or vegetable-based stocks, milk, cream or other dairy based products. Food assembly 16 is typically free of pre-made sauces and chemical preservatives, although each of these may be used if desired. Typically, there is sufficient frozen liquid 22A in order to hold the various items of assembly 16 together as a block or a unit although small pieces of food may be separate from the block or unit. Thus, meat 18 and pieces 20 are usually embedded in frozen liquid 22A.

Food bag 12 may come in a variety of shapes, although it is preferred that the bag have an outer perimeter 24 having substantially straight opposed sides 26A and B and opposed ends 28A and B. Bag 12 has a front 30 and an opposed rear 32 with window 14 disposed along front 30. Any bag suitable to the process may be used. A preferred bag for the present method is described in U.S. Pat. No. 6,033,114 granted to Grimm et al., which was discussed in the Background section of the present application and the contents of which are incorporated herein by reference.

With reference to FIG. 2, a freezing tray 34 is provided for freezing the food items to make up frozen food assembly 16. Tray 34 has a substantially flat bottom wall 36, a pair of opposed substantially flat side walls 38A and 38B and a pair of opposed substantially flat end walls 40A and 40B defining therewithin a rectangular freezing cavity 42. Cavity 42 serves as a mold for producing a frozen molded form made up of frozen food assembly 16.

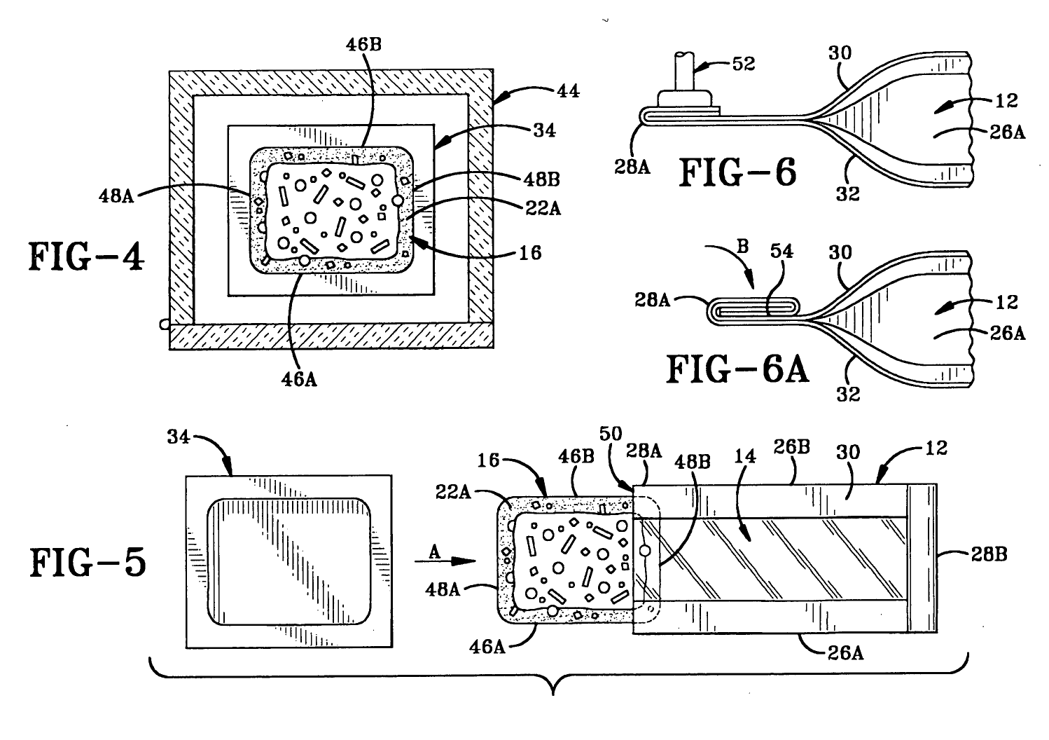

As shown in FIG. 3, meat 18, pieces 20 and liquid 22B which will be frozen to become frozen liquid 22A is placed in cavity 42 of tray 34. At this point, meat 18 and pieces 20 are uncooked and as fresh as possible. Tray 34 with its contents is then placed in a freezer 44 (FIG. 4) in order to freeze food assembly 16 so that it becomes a frozen molded form having the shape of cavity 42 of tray 34 except for the upper surface which remains in whatever form the various parts of the food are disposed. Food assembly 16 is thus a substantially rectangular frozen slab having a rear which is flat and an outer perimeter having straight flat opposed sides 46A and B and straight flat opposed ends 48A and 48B. Preferably, the shape of the frozen molded form when inserted in bag 12 helps align the main part of assembly 16, such as meat 18, with window 14 for desirable display.

Once frozen, food assembly 16 is removed from tray 34 as shown in FIG. 5 and inserted as indicated at Arrow A into the interior of bag 12 via an entrance opening 50 at end 28A. Once food assembly 16 is fully inserted, bag 12 is sealed adjacent end 28A thereof as shown in FIGS. 6 and 6A. More particularly, FIG. 6 shows bag 12 adjacent end 28A being heat sealed by a suitable heat sealing device 52. Preferably, end 28A is then folded over as indicated at Arrow B in FIG. 6A and sealed with an adhesive 54 to further secure the bag in a closed position. The heat sealing of bag 12 provides a sealed environment for containing food assembly 16 in the frozen and liquid states.

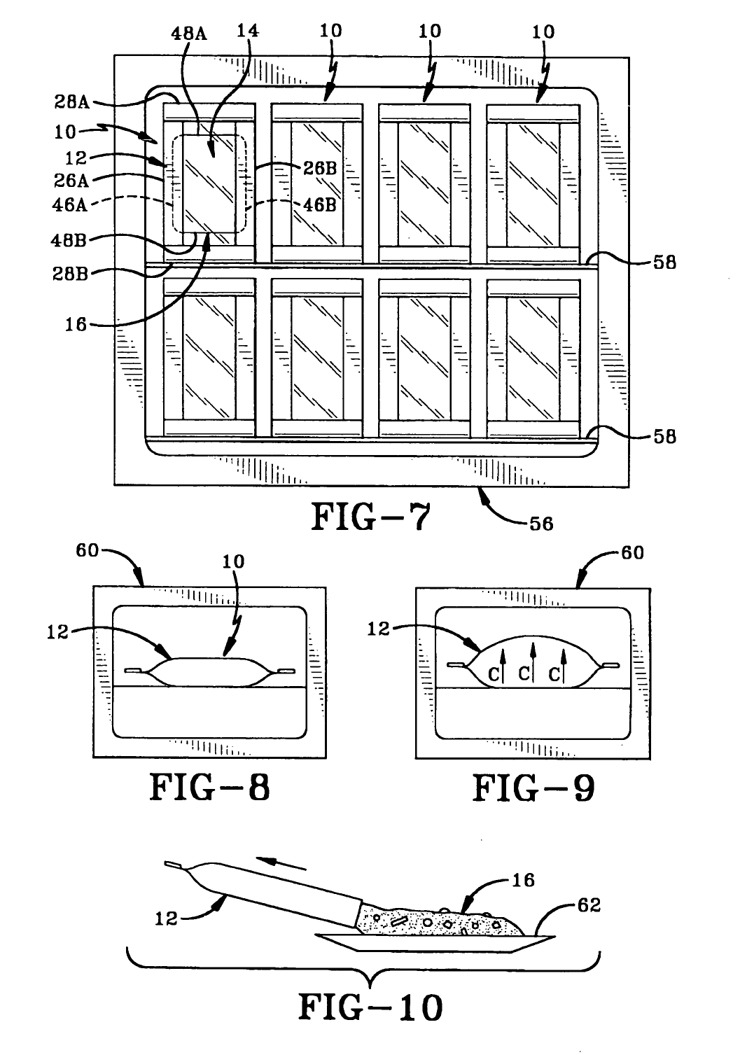

Once food assembly 16 is frozen and sealed within bag 12, it is ready for shipping to stores or other commercial establishments, where it may be displayed in a freezer section 56 as shown in FIG. 7. Packages 10 may be displayed as desired, but are preferably either laid on their rear surfaces or stood upright on one of ends 28 on a shelf 58. Display window 14 allows customers to see the fresh ingredients inside bag 12 to make the product more appealing. Once purchased, the consumer is able to place package 10 while still frozen directly into a standard or microwave oven 60 as shown in FIG. 8 and cook food assembly 16 within bag 12, which expands as indicated at Arrows C in FIG. 9 as steam is generated therewithin. The steam and a degree of pressure which builds up within bag 12 facilitates the cooking of food assembly 16 while bag 12 retains the liquids therewithin during the cooking process. More particularly, bag 12 holds in the steam so that the inside of bag 12 is saturated with steam. As a result, moisture within the food items of assembly 16 remains in the food items to produce a meal which is substantially more moist than that produced by known prior art methods. Once cooked, package 10 is removed from oven 60, bag 12 is opened and food assembly 16 is removed from bag 12 as indicated in FIG. 10 onto a platter 62 or the like. Alternately, window 14 may be cut open and the meal eaten directly from the bag if desired while retaining the liquids therein. Bag 12 is also conveniently removable from oven 60 after cooking without the user getting burned. More particularly, the folded ends 28 of bag 12 are only minimally heated during cooking and thus serve as relatively cool handles for removal of bag 12 to avoid such a burn risk.

Thus, package 10 and the method of producing and using the same provides a very convenient way of obtaining a very healthy and nutritionally balanced meal for the consumer. In addition, the use of fresh uncooked ingredients which are immediately frozen and stored in bag 12 provides a product which when cooked as described is a substantial improvement over the prior art methods of reheating food that has already been cooked. The retention of steam within bag 12 minimizes moisture loss from the food to keep the meal quite moist, especially in contrast to packages that are opened during the cooking process. This method also allows the production of a meal having a high quality taste without the necessity of providing preformed sauces, as previously noted. In addition, this method is effective without the use of chemical preservatives.

In the foregoing description, certain terms have been used for brevity, clearness, and understanding. No unnecessary limitations are to be implied therefrom beyond the requirement of the prior art because such terms are used for descriptive purposes and are intended to be broadly construed.

Moreover, the description and illustration of the invention is an example and the invention is not limited to the exact details shown or described.

1. An apparatus comprising:
a bag which is freezable and at least one of ovenable and microwaveable; and
a frozen food assembly which includes uncooked food and is disposed within the bag.

2. The apparatus of claim 1 wherein the uncooked food includes a meat.

3. The apparatus of claim 2 wherein the uncooked food includes at least one of a fruit and a vegetable.

4. The apparatus of claim 3 wherein the food assembly includes a frozen liquid external to each of the meat and the at least one of a fruit and a vegetable.

5. The apparatus of claim 4 wherein the meat and the at least one of a fruit and a vegetable are embedded, in the frozen liquid.

6. The apparatus of claim 1 wherein the food assembly includes a frozen liquid external to the uncooked food.

7. The apparatus of claim 6 wherein the frozen liquid includes a stock.

8. The apparatus of claim 6 wherein the frozen liquid includes a dairy-based liquid.

9. The apparatus of claim 7 wherein the frozen liquid includes an infused oil.

10. The apparatus of claim 1 wherein the uncooked food includes at least one of a fruit and a vegetable.

11. The apparatus of claim 1 wherein the food assembly is free of chemical preservatives.

12. The apparatus of claim 1 wherein the bag includes a transparent window through which the food assembly is viewable.

13. The apparatus of claim 1 wherein the bag includes a liquid-impermeable barrier adapted to retain liquids within the bag.

14. A method comprising the steps of:
providing frozen uncooked food in a bag;
sealing the bag so that the bag is impermeable to liquids; and
cooking the food in the bag while the bag is sealed.

15. The method of claim 14 wherein the step of providing includes the step of providing frozen uncooked food which includes a meat.

16. The method of claim 15 wherein the step of providing includes the step of providing frozen uncooked food which includes at least one of a vegetable and a fruit.

17. The method of claim 14 wherein the step of providing includes the step of providing a frozen liquid in which the uncooked food is embedded.

18. The method of claim 17 further including the steps of freezing the uncooked food and liquid in a container cavity to produce a frozen molded form of the uncooked food and liquid; and inserting the frozen molded form into the bag.

19. The method of claim 14 wherein the step of providing includes the step of providing frozen uncooked food which includes at least one of a vegetable and a fruit.

20. The method of claim 14 further including the step of displaying the frozen uncooked food in a commercial establishment with the food visible through a window of the bag.
